(19) United States
(12) Patent Application Publication
(10) Pub. No.: US 2019/0055062 A1
(43) Pub. Date: Feb. 21, 2019

(54) FULLY COLLAPSIBLE HANDLE SYSTEM AND DEVICE

(71) Applicant: Dublyu, LLC, Provo, UT (US)

(72) Inventor: Tyler Winn, Provo, UT (US)

(73) Assignee: Dublyu, LLC, Provo, UT (US)

(21) Appl. No.: 16/106,943

(22) Filed: Aug. 21, 2018

Related U.S. Application Data
(60) Provisional application No. 62/548,175, filed on Aug. 21, 2017.

(51) Int. Cl. B65D 23/10; H04B 1/3888

(52) U.S. Cl. CPC B65D 23/104; A45F 5/10; H04B 1/3888

(57) ABSTRACT

A collapsible handle system and device are provided. The system provides a device having a first surface which is inset into the first surface. The system also includes a strap which is connected to an anchor and a slider. The strap and the slider are also disposed within the channel. The device provides a channel. The device further provides a strap connected to an anchor and a slider. The strap and slider are disposed within the channel. As the slider is moved along the channel, the strap becomes a handle.

### PRIOITY CLAIM

This application claims the benefit of U.S. Provisional Patent Application Ser. No. 62/548,175 which was filed on Aug. 21, 2017. This application is hereby incorporated by reference in its entirety.

### BACKGROUND

### 1.Technical Field

This disclosure relates generally to a collapsible handle system and device. More specifically the system disclosed herein provides a flat line strap that may be selectively arranged to form a handle or, when not in use, may be stowed within a surface upon which it is mounted. The device provides a strap and a sliding member disposed within a corresponding channel that may be used to deploy or stow the strap as a handle.

### 2. Description of the Related Art

Handles are ubiquitous in human society. Since man's early history, man has frequently been his own beast of burden to transport vessels or other loads from one point to another. Various aids have been developed to assist in that endeavor, which is no simple task due to the structure and shape of the human body. For example, man has used knapsacks, backpacks, pouches on arm slings, yokes, and other devices to provide an easier way to carry a heavier load over a farther distance. One aid that has been developed is the advent of an integral handle. For example, jars, pots, bags, and other devices for moving a load from one place to another have been developed with an integral handle which is effectively a hole built into the device which provides relatively small opening and surface that may be grasped by a human hand. Handles have been implemented in virtually every device for a human carried load since the advent of handles.

Over time, ergonomics and convenience have also become factors for handle installation and use. For example, handles that are too narrow may cut into a person's hands when a load is too heavy while handles that are too long may cause the person to trip and fall. Handles constructed in relatively hard materials (e.g. pots, luggage, and briefcases) make these devices difficult to store because the handles disposed on these devices alter the overall shape of the device which, in turn, prevents the devices from nesting one inside another or prevents the close stacking of these devices next to each other. Handles constructed in relatively soft materials (e.g., a backpack handle, a purse handle, and plastic shopping bags) frequently cause the devices to which they are attached to deform substantially when a load is disposed within the devices. Handles placed on devices also frequently cause the devices to be oddly shaped to accommodate the installation of handles.

It is therefore one object of this disclosure to provide a collapsible handle system and device. It is another object of this disclosure to provide a strap handle that may be adjustable. It is another object of this disclosure to provide a strap handle that may be fully retracted into a surface of a device on which it is mounted.

### SUMMARY

Disclosed herein is a system which includes a device having a first surface. A channel is inset into the first surface. The system further includes a strap connected to an anchor and a slider. The strap and the slider may also be disposed within the channel.

Also disclosed herein is a device. The device may implement a channel. The device may further include a strap connected to an anchor and a slider. The strap and the slider may also be disposed within the channel implemented by the device.

### BRIEF DESCRIPTION OF DRAWINGS

The accompanying drawings illustrate several embodiments of a hanging and shipping support system and device. The illustrated embodiments are exemplary and do not limit the scope of the disclosure.

FIG. 1 illustrates a front view of an embodiment of a fully collapsible handle system and device implemented on an exemplary surface.

FIG. 2 illustrates a cross sectional side view of an embodiment of a fully collapsible handle system and device implemented on an exemplary surface with the handle in a stowed configuration.

FIG. 3 illustrates a cross sectional side view of an embodiment of a fully collapsible handle system and device implemented on an exemplary surface with the handle in a deployed configuration.

FIG. 4 illustrates a bottom side view of an embodiment of a fully collapsible handle system and device implemented on an exemplary surface with the handle in a stowed configuration.

FIG. 5 illustrates a bottom side view with an embodiment of a fully collapsible handle system and device implemented on an exemplary surface with the handle in a deployed configuration.

FIG. 6 illustrates a perspective view of an embodiment of a fully collapsible handle system and device implemented on an exemplary surface with the handle in a stowed configuration.

FIG. 7 illustrates a perspective view of an embodiment of a fully collapsible handle system and device implemented on an exemplary surface with the handle in a deployed configuration.

FIG. 8 illustrates a perspective view of an alternative embodiment of a fully collapsible handle system.

FIG. 9 illustrates a perspective view of an alternative embodiment of a fully collapsible handle system on another exemplary device.

### DETAILED DESCRIPTION OF PREFERRED EMBODIMENTS

In the following description, for purposes of explanation and not limitation, specific techniques and embodiments are set forth, such as particular techniques and configurations, in order to provide a thorough understanding of the system and device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein.

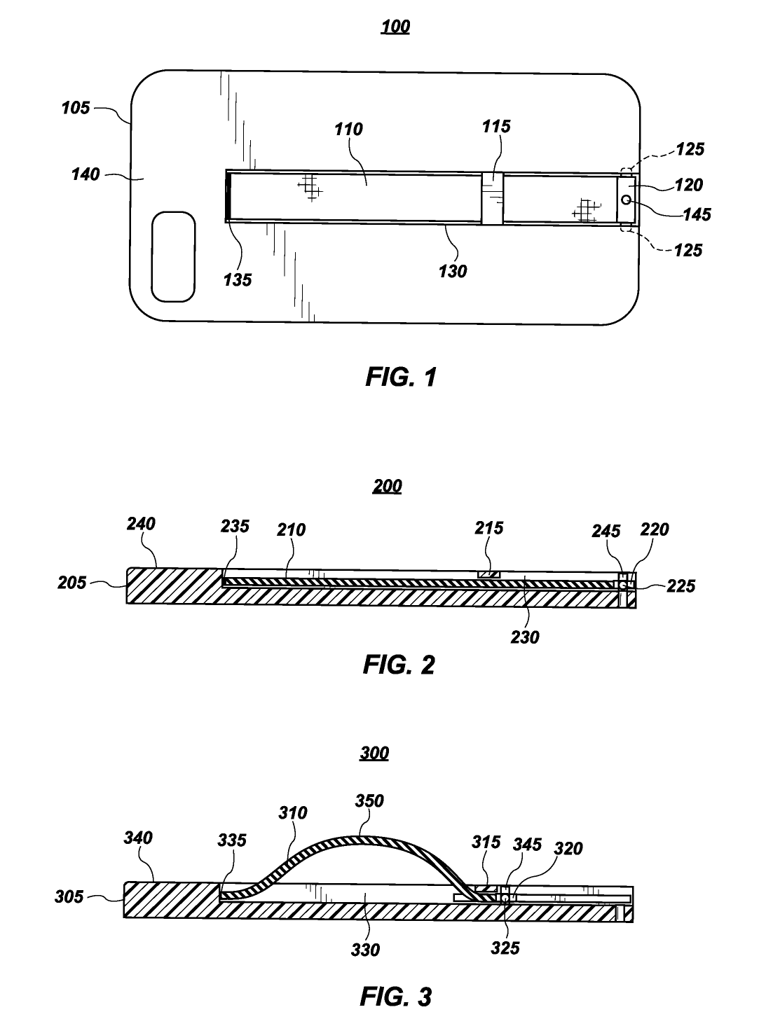

FIG. 1 illustrates a fully collapsible handle system 100. Handle system 100 includes a device 105 having a first surface 140 into which handle system 100 is installed. Device 105 may be virtually any object that may be fitted with a handle. As shown in FIG. 1, device 105 is implemented as a case for a mobile smart phone for the purposes of explanation. However, handle system 100 may be implemented in virtually any device that includes a soft or hard surface and facilitate handles in bags, luggage, briefcases, purses, backpacks, carrying cases, or any other device commonly used to store and carry other items.

Disposed within device 105 is a strap 110. Strap 110 may be disposed within device 105 such that it is effectively flush with first surface 140. In other words, strap 110 may be disposed such that a top most surface of strap 110 sits at a height that is equal to the height of first surface 140. Strap 110 may be substantially flush with first surface 140 which may be interpreted as being flush to within manufacturing tolerances. Strap 110 may be constructed from a number of different materials. Preferably, strap 110 may be constructed using a malleable or flexible material, such as fabrics, leather, rubber, latex, webbing, woven strap material, or other malleable or flexible materials. Other materials are possible, such as multiple hinged links of non-flexible material, such metal. Strap 110 may be connected on opposite ends of channel 130 which is first surface 140 of device 105. For example, strap 110 may be permanently attached to device 105 by an anchor 135 on a first end and to a slider 120 on a second end, as will be discussed below. Strap 110 may be permanently attached to device 105 (including slider 120) by adhesives, glues, knotting, a key installed in a horizontal groove through a hole disposed in strap 110, or any other mechanism or method of attaching strap 110 to device 105 known in the art.

Strap 110 may be implemented such that strap 110 may be selectively stowed or deployed depending on a particular user's wishes. Deploying (and stowing) strap 110 may be accomplished by moving slider 120 along channel 130 towards anchor 135. For example, when a user wishes to deploy strap 110, a user may push slider 120 towards anchor 135 causing strap 110 to elongate between slider stop 115 and anchor 135, providing a handle disposed between slider stop 115 and anchor 135 when slider 120 abuts slider stop 115. Slider stop 115 is shown as bridging channel 130 but it should be noted that slider stop need not be so positioned and may be positioned anywhere in channel 130 and may be implemented as bump stops disposed on the sides or bottom of channel 130. Strap 110 may further be disposed underneath slider stop 115 in channel 130. Stowing strap 110 may be accomplished by moving slider 120 back along channel 130 away from anchor 135 which causes strap 110 to shorten between slider stop 115 and anchor 135 and be stowed in channel 130. As will be discussed in further detail below, channel 130 may be fitted with grooves into which slider tabs 125 may be inserted. Slider tabs 125 may be disposed in these grooves to provide a low surface area surface to facilitate sliding and provide additional stability to slider 120.

It is also noted that slider 120 may be retained in either the deployed or stowed position along channel 130 by pinning slider 120 to channel 130 or to first surface 140 by a pin 145. Pin 145 is merely exemplary of one way of causing slider 120 to be disposed in a deployed or stowed condition. Other retainers and retaining devices may be used to hold slider 120 in a particular position in channel 130.

FIG. 2 illustrates a cross sectional side view of an embodiment of a fully collapsible handle system 200 and device implemented on an exemplary surface with the handle in a stowed configuration. Handle system 200 may be similar in implementation and description to handle system 100 shown in FIG. 1, above. As shown in FIG. 2, an exemplary device 205, which is a mobile smart phone case in FIG. 2, is illustrated for explanatory purposes. Device 205 includes a strap 210 which is disposed within a channel 230. Strap 210 is connected between an anchor point 235 on a first end of strap 210 and a slider 220 on a second end of strap 210. Slider 220 may be disposed within channel 230 by the use of slider tabs 225 which may be inserted into corresponding grooves in channel 230 to facilitate sliding slider 220 along channel 230.

Slider 225 may slide along channel 230 up to stopper 215. As slider 225 slides towards anchor 235, strap 210 between stopper 215 and anchor 235 is elongated to create a handle on device 205. When slider 225 engages stopper 215, a retainer 245 may be installed or actuated to cause slider 225 to be retained in a deployed position to provide a handle on device 205.

It should also be noted that in the stowed configuration for strap 210 shown in FIG. 2, strap 210 is installed such that strap 210 is flush with a first surface 240 of device 205 such that the first surface 240 of device 205 is flat or substantially flat, meaning that first surface 240 with strap 210 is flat in a manner commensurate with manufacturing tolerances.

FIG. 3 illustrates a cross sectional side view of an embodiment of a fully collapsible handle system 300 and device implemented on an exemplary surface with the handle in a deployed configuration. Handle system 300 may be similar in implementation and description to handle system 200 shown in FIG. 2, above. For example, FIG. 3 illustrates a continuation of FIG. 2 as slider 220 in FIG. 2 is slid along channel 220 towards anchor 235 to create a handle portion in strap 210. Turning, to FIG. 3, an exemplary device 305, which is a mobile smart phone case in FIG. 3, is illustrated for explanatory purposes. Device 305 includes a strap 310 which is disposed within a channel 330. Strap 310 is connected between an anchor point 335 on a first end of strap 310 and a slider 320 on a second end of strap 310. Slider 320 may be disposed within channel 330 by the use of slider tabs 325 which may be inserted into corresponding grooves in channel 330 to facilitate sliding slider 320 along channel 330.

Slider 325 may slide along channel 330 up to stopper 315. As slider 325 slides towards anchor 335, strap 310 between stopper 315 and anchor 335 is elongated to create a handle on the back of device 305. When slider 325 engages stopper 315, a retainer 345 may be installed or actuated to cause slider 325 to be retained in a deployed position to provide a handle on device 305.

Accordingly, as shown in FIG. 3, a handle portion 350 is created by the elongation of strap 310 between stopper 315 and anchor 335. Handle portion 350 may be suitable for grasping by a whole hand or by one or more fingers. When a user has finished using handle portion 350, slider 325 may be slid back to its original position, shown in FIG. 2, which draws strap 310 back into channel 330 and stows strap 310 in a manner that is flush with a first surface 340 of device 305.

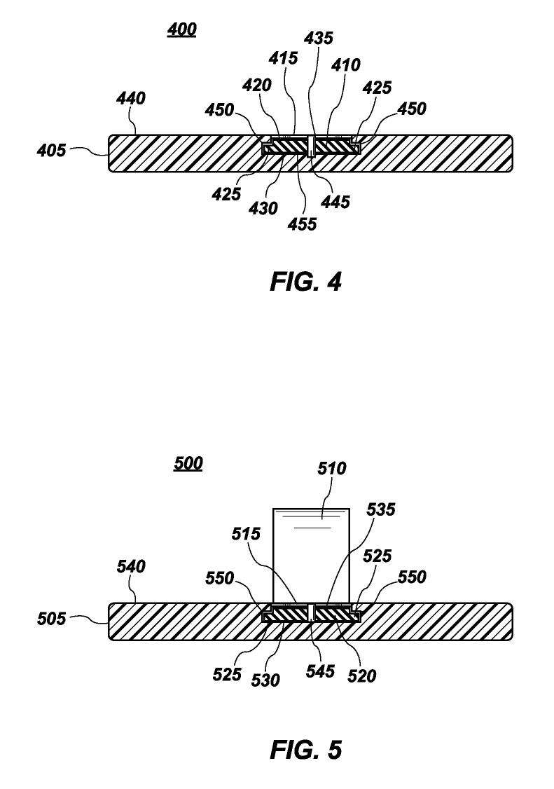

FIG. 4 illustrates a bottom side view of an embodiment of a fully collapsible handle system 400 and device implemented on an exemplary surface with the handle in a stowed configuration. Handle system 400 may be similar in implementation and description to handle systems 100-300, shown in FIGS. 1-3, above. FIG. 4 provides additional illustration particularly with respect to channel 430.

As shown in FIG. 4, an exemplary device 405, which is a mobile smart phone case in FIG. 4, is illustrated for explanatory purposes. Device 405 includes a strap 410 which is disposed within a channel 430. Strap 410 is connected between an anchor point 435 on a first end of strap 410 and a slider 420 on a second end of strap 410. Slider 420 may be disposed within channel 430 by the use of slider tabs 425 which may be inserted into corresponding grooves 450 in channel 230 to facilitate sliding slider 420 along channel 430. Slider tabs 425 may be shaped and configured to ride in grooves 450 to allow slider 425 to ride and slide through channel 430, as previously discussed. Channel 430 may be inset into first surface 440, providing a channel bottom, which is a second surface 455. Second surface 455 may be below surface 440 to accommodate slider 420 and strap 410 according to the disclosure herein.

Slider 425 may slide along channel 430 up to stopper 415. As slider 425 slides towards anchor 435, strap 410 between stopper 415 and anchor 435 is elongated to create a handle on device 405. When slider 425 engages stopper 415, a retainer 445 may be installed or actuated to cause slider 425 to be retained in a deployed position to provide a handle on device 405.

It should also be noted that in the stowed configuration for strap 410 shown in FIG. 4, strap 410 is installed such that strap 410 is flush with a first surface 440 of device 405 such that the first surface 440 of device 405 is flat or substantially flat, meaning that first surface 440 with strap 410 is flat in a manner commensurate with manufacturing tolerances.

FIG. 5 illustrates a bottom side view with an embodiment of a fully collapsible handle system 500 and device implemented on an exemplary surface with the handle in a deployed configuration. Handle system 500 may be similar in implementation and description to handle system 400 shown in FIG. 4, above. For example, FIG. 5 illustrates a continuation of FIG. 4 as slider 420 in FIG. 4 is slid along channel 430 towards anchor 435 to create a handle portion in strap 410. Turning, to FIG. 5, an exemplary device 505, which is a mobile smart phone case in FIG. 5, is illustrated for explanatory purposes. Device 505 includes a strap 510 which is disposed within a channel 530. Strap 510 is connected between an anchor point 535 on a first end of strap 510 and a slider 520 on a second end of strap 510. Slider 520 may be disposed within channel 530 by the use of slider tabs 525 which may be inserted into corresponding grooves 550 in channel 530 to facilitate sliding slider 520 along channel 530.

Slider 525 may slide along channel 530 up to stopper 315. As slider 525 slides towards anchor 535, strap 510 between stopper 515 and anchor 535 is elongated to create a handle on device 530. When slider 525 engages stopper 515, a retainer 545 may be installed or actuated to cause slider 525 to be retained in a deployed position to provide a handle on device 505.

Accordingly, as shown in FIG. 5, a handle portion 550 is created by the elongation of strap 510 between stopper 515 and anchor 535. Handle portion 550 may be suitable for grasping by a whole hand or by one or more fingers. When a user has finished using handle portion 550, slider 525 may be slid back to its original position, shown in FIG. 4, which draws strap 510 back into channel 530 and stows strap 510 in a manner that is flush with a first surface 540 of device 505.

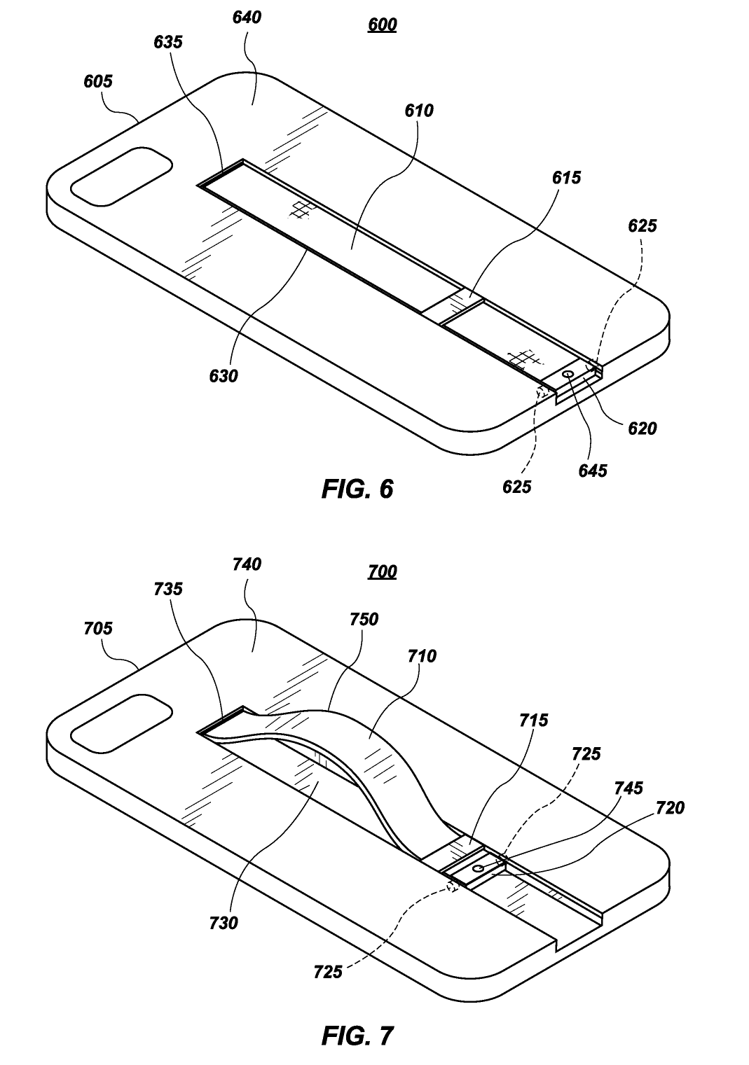

FIG. 6 illustrates a perspective view of an embodiment of a fully collapsible handle system 600 and device implemented on an exemplary surface with the handle in a stowed configuration. Handle system 600 may be similar in implementation and description to handle systems 100-500 shown in FIGS. 1-5, above. As shown in FIG. 6, an exemplary device 605, which is a mobile smart phone case in FIG. 6, is illustrated for explanatory purposes. Device 605 includes a strap 610 which is disposed within a channel 630. Strap 610 is connected between an anchor point 635 on a first end of strap 610 and a slider 620 on a second end of strap 610. Slider 620 may be disposed within channel 630 by the use of slider tabs 625 which may be inserted into corresponding grooves in channel 630 to facilitate sliding slider 620 along channel 630.

Slider 625 may slide along channel 360 up to stopper 615. As slider 625 slides towards anchor 635, strap 610 between stopper 615 and anchor 635 is elongated to create a handle on device 605. When slider 625 engages stopper 615, a retainer 645 may be installed or actuated to cause slider 625 to be retained in a deployed position to provide a handle on device 605.

It should also be noted that in the stowed configuration for strap 610 shown in FIG. 6, strap 610 is installed such that strap 610 is flush with a first surface 640 of device 605 such that the first surface 640 of device 605 is flat or substantially flat, meaning that first surface 640 with strap 610 is flat in a manner commensurate with manufacturing tolerances.

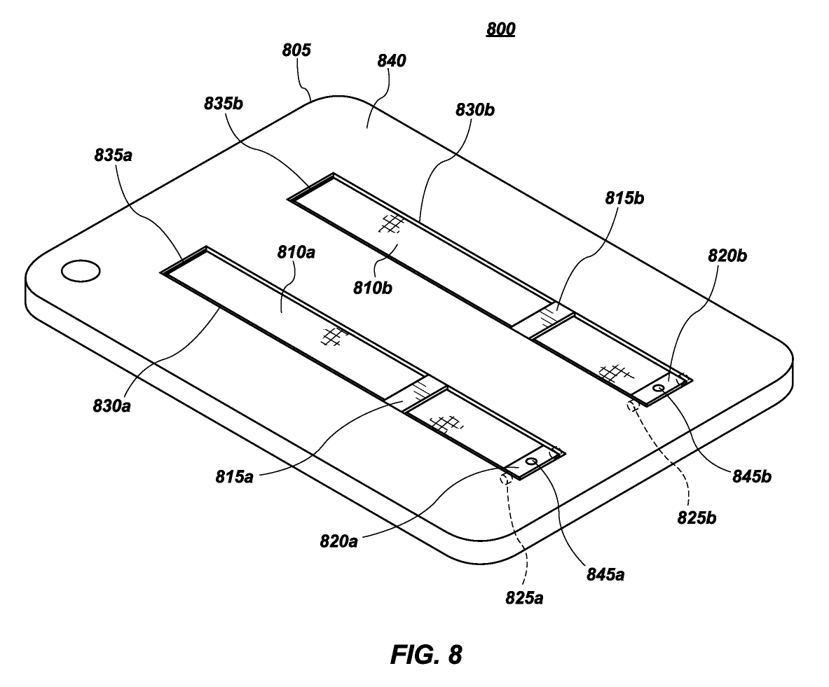

FIG. 7 illustrates a perspective view of an embodiment of a fully collapsible handle system 700 and device implemented on an exemplary surface with the handle in a deployed configuration. Handle system 700 may be similar in implementation and description to handle systems 100-600 shown in FIGS. 1-6, above. For example, FIG. 7 illustrates a continuation of FIG. 6 as slider 620 in FIG. 6 is slid along channel 620 towards anchor 635 to create a handle portion in strap 610. Turning, to FIG. 7, an exemplary device 705, which is a mobile smart phone case in FIG. 7, is illustrated for explanatory purposes. Device 705 includes a strap 710 which is disposed within a channel 730. Strap 710 is connected between an anchor point 735 on a first end of strap 710 and a slider 720 on a second end of strap 710. Slider 720 may be disposed within channel 730 by the use of slider tabs 725 which may be inserted into corresponding grooves in channel 730 to facilitate sliding slider 720 along channel 730.

Slider 725 may slide along channel 730 up to stopper 715. As slider 725 slides towards anchor 735, strap 710 between stopper 715 and anchor 735 is elongated to create a handle on the back of device 705. When slider 725 engages stopper 715, a retainer 745 may be installed or actuated to cause slider 725 to be retained in a deployed position to provide a handle on device 705.

Accordingly, as shown in FIG. 7, a handle portion 750 is created by the elongation of strap 710 between stopper 715 and anchor 735. Handle portion 750 may be suitable for grasping by a whole hand or by one or more fingers. When a user has finished using handle portion 750, slider 725 may be slid back to its original position, shown in FIG. 7, which draws strap 710 back into channel 730 and stows strap 710 in a manner that is flush with a first surface 740 of device 705.

FIG. 8 illustrates a perspective view of an alternative embodiment of a fully collapsible handle system 800. Handle system 800 may be similar in implementation and description to handle systems 100-700 shown in FIGS. 1-7 discussed above. In this embodiment, however, two handle devices are installed on a first surface 840. This embodiment is merely exemplary as it is possible to put any number of handle devices on a particular device. As shown in FIG. 8, device 805 is implemented as a case for a mobile smart phone for the purposes of explanation.

Disposed within device 805 are straps 810a and 810b. Straps 810a and 810b may be disposed within device 805 such that each are effectively flush with first surface 840. In other words, strap 810a and strap 810b may be disposed such that a top most surface of strap 810 sits at a height that is equal to the height of first surface 840. Straps 810a and 810b may be substantially flush with first surface 840 which may be interpreted as being flush to within manufacturing tolerances.

Straps 810a and 810b may be connected on opposite ends of channels 830a and 830b which attached to first surface 840 of device 805. For example, straps 810a and 810b may be permanently attached to device 805 by anchors 835a and 835b on a first end and to sliders 820a and 820b on a second end. Straps 810a and 810b may be permanently attached to device 805 (including sliders 820a and 820b) by adhesives, glues, knotting, a key installed in a horizontal groove through a hole disposed in straps 810a and 810b, or any other mechanism or method of attaching straps 810a and 810b to device 805 known in the art.

Straps 810a and 810b may be implemented such that straps 810a and 810b may be selectively stowed or deployed depending on a particular user's wishes. Deploying (and stowing) straps 810a and 810b may be accomplished by moving sliders 820a and 820b along channels 830a and 830b towards anchors 835a and 835b. For example, when a user wishes to deploy straps 810a and 810b, a user may push slider 810 towards anchors 835a and 835b causing straps 810a and 810b to elongate between slider stops 815a and 815b and anchors 835a and 835b, providing a handle disposed between slider stops 815a and 815b and anchors 835a and 835b. Stowing straps 810a and 810b may be accomplished by moving sliders 820a and 820b back along channels 830a and 830b away from anchors 835a and 835b which causes straps 810a and 810b to shorten between slider stops 815a and 815b and anchors 835a and 835b and be stowed in channel 830a and 830b. Channels 830a and 830b may be fitted with grooves into which slider tabs 825a and 825b may be inserted. Slider tabs 825a and 825b may be disposed in these grooves to provide a low surface area surface to facilitate sliding and provide additional stability to sliders 820a and 820b.

It is also noted that sliders 820 may be retained in either the deployed or stowed position along channels 830a and 830b using retainers 845a and 845b.

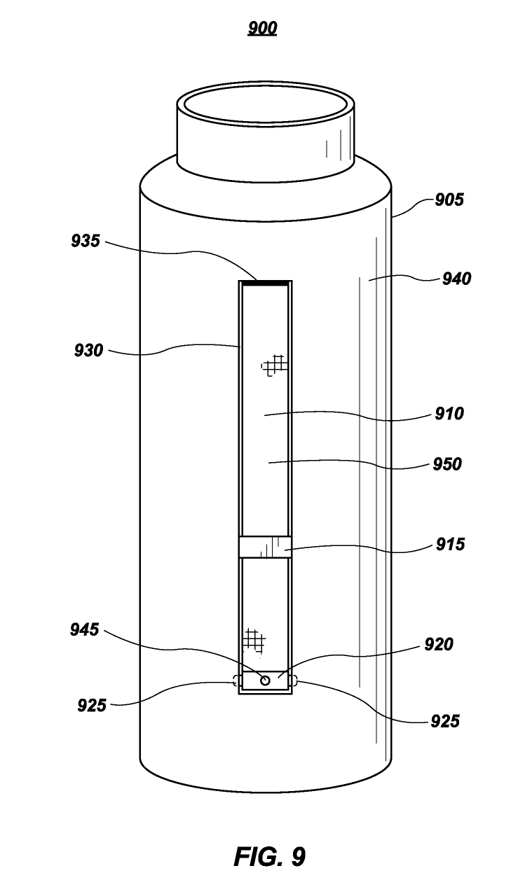

FIG. 9 illustrates a perspective view of an alternative embodiment of a fully collapsible handle system 900 on another exemplary device. As shown in FIG. 9, a bottle 905 is provided with handle system 900. Handle system 900 is implemented in a side of bottle 905 which may be a water bottle in this non-limiting example. Bottle 905 may include a strap 910 which is disposed flush along an outside surface of bottle 905. Strap 910 may be disposed in channel 930 and attached on a first end to an anchor 935 and on a second end to a slider 920. Slider 920 may slide through channel 930 by use of slider tabs 925 which are installed in grooves inset into channel 930, as discussed above. Slider 920 may be retained in position (either stowed or deployed) by use of a retainer 945, which is shown in FIG. 9 as a pin, although many different mechanisms are possible. Slider 920 may slide towards slider stop 915 which elongates strap 910 between anchor 935 and slider stop 920 and which forms a handle portion 950 which may be serve as a handle for holding bottle 905.

Slider 920 may be slid back away from anchor 935 which may shorten strap 910 between anchor 935 and slider stop 915 in a manner that causes strap 910 to be stowed within channel 930. Slider 920 may be further retained in this stowed position by retainer 945. This stowed position retains strap 910 in channel 930 and stows strap 910 in a manner that is flush with a first surface 940 of device 905.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system, comprising:
a device having a first surface, a channel being inset into the first surface;
a strap connected to an anchor and a slider, wherein the strap and the slider are disposed within the channel.

2. The system of claim 1, further comprising a slider stop.

3. The system of claim 2, wherein the strap is disposed under the slider stop in the channel.

4. The system of claim 1, wherein the slider further includes slider tabs.

5. The system of claim 4, wherein the channel further includes grooves.

6. The system of claim 5, wherein the slider tabs on the slider are positioned within the grooves of the channel.

7. The system of claim 1, further comprising a retainer.

8. The system of claim 1, wherein the device is a mobile smart phone case.

9. The system of claim 1, wherein the device is a bottle.

10. The system of claim 1, wherein the strap provides a handle when the slider abuts a slider stop disposed within the channel.

11. A device, comprising:
a channel;
a strap connected to an anchor and a slider, wherein the strap and the slider are disposed within the channel.

12. The device of claim 11, further comprising a slider stop.

13. The device of claim 12, wherein the strap is disposed under the slider stop in the channel.

14. The device of claim 11, wherein the slider further includes slider tabs.

15. The device of claim 14, wherein the channel further includes grooves.

16. The device of claim 15, wherein the slider tabs on the slider are positioned within the grooves of the channel.

17. The device of claim 11, further comprising a retainer.

18. The device of claim 11, wherein the strap provides a handle when the slider abuts a slider stop disposed within the channel.

19. The device of claim 11, wherein the strap is connected to the channel on a first end of the strap.

20. The device of claim 11, wherein the strap is connected to the slider on a second end of the strap.
